(19) United States
(12) Patent Application Publication
(10) Pub. No.: US 2020/0110302 A1
(43) Pub. Date: Apr. 9, 2020

(54) DISPLAY PANEL AND DISPLAY DEVICE

(71) Applicant: Sharp Kabushiki Kaisha, Sakai City (JP)

(72) Inventors: Yasuhiro KUROE, Sakai City (JP); Noriyuki OHASHI, Sakai City (JP)

(21) Appl. No.: 16/589,386

(22) Filed: Oct. 1, 2019

Related U.S. Application Data
(60) Provisional application No. 62/741,097, filed on Oct. 4, 2018.

(51) Int. Cl. G02F 1/1333; G02F 1/1345; G09G 3/36

(52) U.S. Cl. CPC G02F 1/133308; G09G 3/3611; G02F 1/13452

(57) ABSTRACT

A display panel includes display pixels, a display area in which an image is displayed, and a non-display area in which no image is displayed. A boundary between the display area and the non-display area has a shape including a curve portion. The display pixels include center section display pixels and peripheral section display pixels. The center section display pixels are disposed in a center section of the display area. The peripheral section display pixels are disposed in sections of the display panel including the boundary between the display area and the non-display area. The peripheral section display pixels are formed as if by dividing the center section display pixels.

### CROSS REFERENCE TO RELATED APPLICATION

This application claims priority from U.S. Provisional Patent Application No. 62/741,097 filed on Oct. 4, 2018. The entire contents of the priority application are incorporated herein by reference.

### TECHNICAL FIELD

The technology described herein relates to a display panel and a display device.

### BACKGROUND ART

Conventionally, a liquid crystal display device having a display area formed into a non-rectangular shape such as a circular shape is known. An example of the liquid crystal display device is disclosed in Japanese Patent Publication No. 5112961. In the liquid crystal display device, an elliptical display area has aperture ratio adjustment picture elements each having an aperture ratio adjusted to be low relative to the center section by shielding part of the peripheral section against light. Each aperture ratio adjustment picture element has colored layers of the respective colors, namely, red (R), green (G), and blue (B). These colored layers are configured to be lighted up in a shape including a curve along the elliptical outer shape. This makes it possible to prevent color balance degradation in the peripheral section of the display area while smoothly displaying the shape of the peripheral section (elliptical shape).

Each aperture ratio adjustment picture element of the liquid crystal display device described in Japanese Patent Publication No. 5112961 has an aperture ratio adjusted by forming light-shielding portions with respect to colored layers of the respective colors, namely, R, G, and B so as to light up each colored layer in the same shape. The light-shielding portion has a predetermined size so as to form the colored layer into a shape including a curve, and is formed with respect to the colored layer of each color. Accordingly, the light-shielding portion sometimes occupies a large area of an aperture ratio adjustment picture element. This poses the problem of darkening the peripheral section of the display area and increasing luminance variations between the center section and the peripheral section of the display area.

### SUMMARY

The technology described herein has been completed on the basis of the above situation and has as its object to smoothly display the shape of the peripheral section of a display area with good color balance even in a display area having a peripheral section including a curve portion and suppress luminance variations between the center section and the peripheral section.

A display panel includes display pixels arranged in a plane of the display panel, a display area in which an image is displayed, and a non-display area in which no image is displayed. The boundary between the display area and the non-display area has a shape including a curve portion. the display pixels include center section display pixels disposed in a center section of the display area and peripheral section display pixels disposed in sections of the display panel including the boundary between the display area and the non-display area. The peripheral section display pixels are formed as if by dividing the center section display pixels.

A display device includes the display panel described above.

According to the technology described herein, it is possible to smoothly display the shape of the peripheral section of a display area with good color balance, even if the display area has a peripheral section including a curve portion, and suppress luminance variations between the center section and the peripheral section.

### BRIEF DESCRIPTION OF THE DRAWINGS

FIG. 1 is a plan view of a liquid crystal display device according to a first embodiment.

FIG. 2 is a sectional view taken along line II-II in FIG. 1.

FIG. 3 is an enlarged view of a frame border portion III in FIG. 1.

FIG. 4 is an equivalent circuit schematic of a frame border portion IV in FIG. 3.

FIG. 5 is a view showing a liquid crystal panel according to comparative example 1, which corresponds to FIG. 3.

FIG. 6 is a view showing a liquid crystal panel according to a modification, which corresponds to FIG. 3.

FIG. 7 is an equivalent circuit schematic of a frame border portion IIV in FIG. 6.

FIG. 8 is view showing a liquid crystal panel according to the second embodiment, which corresponds to FIG. 3.

FIG. 9 is a view showing a liquid crystal panel according to comparative example 2, which corresponds to FIG. 3.

### DETAILED DESCRIPTION

### First Embodiment

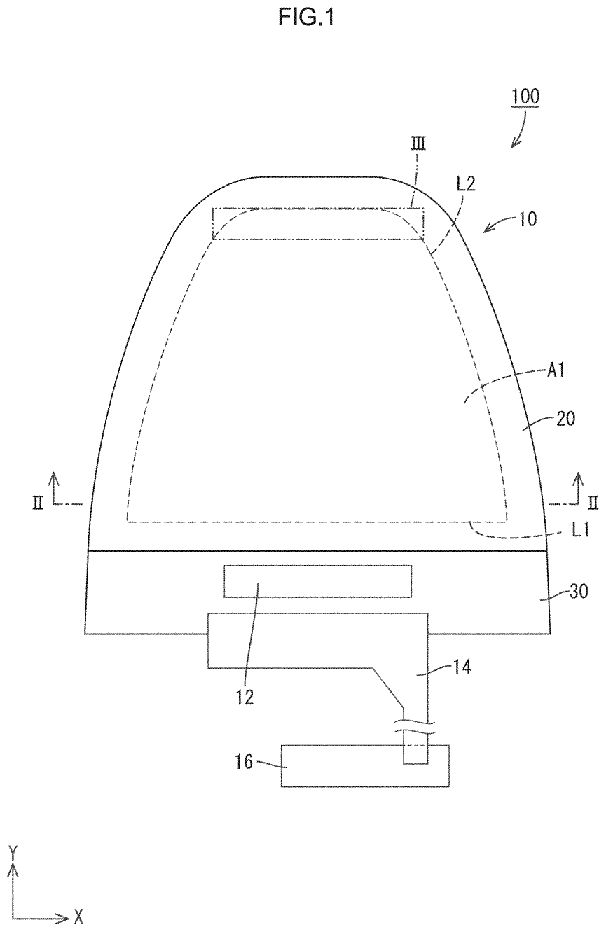

invention first embodiment will be described with reference to FIGS. 1 to 4. The present embodiment will exemplify a liquid crystal display device 100 including a liquid crystal panel 10. X-axes, Y-axes, and Z-axes may be present in the drawings. The axes in each drawing correspond to the respective axes in other drawings.

As illustrated in the plan view of FIG. 1, the liquid crystal display device 100 includes the liquid crystal panel 10 whose outer shape in plan view includes a curve portion and a lighting device that irradiates the liquid crystal panel 10 with light used for display. A center section of the liquid crystal panel 10 is defined as a display area A1 on which an image is displayed. An outer peripheral section in a picture frame shape surrounding the display area A1 is defined as a non-display area A2 on which no image is displayed. The boundary between the display area A1 and the non-display area A2 ideally has a shape including a curve portion L2 indicated by the chain line in FIG. 1. More specifically, the boundary is constituted by a straight line portion L1 along the X-axis direction and the curve portion L2 formed in an arc shape so as to connect the two ends of the straight line portion L1.

An IC chip 12 and a flexible substrate 14 are mounted in the non-display area A2 alongside the straight line portion L1 described above. The IC chip 12 is an electronic component for driving the liquid crystal panel 10. The flexible substrate 14 is a substrate for connecting a control board 16 to the liquid crystal panel 10. The control board 16 externally supplies various types of input signals to the IC chip 12.

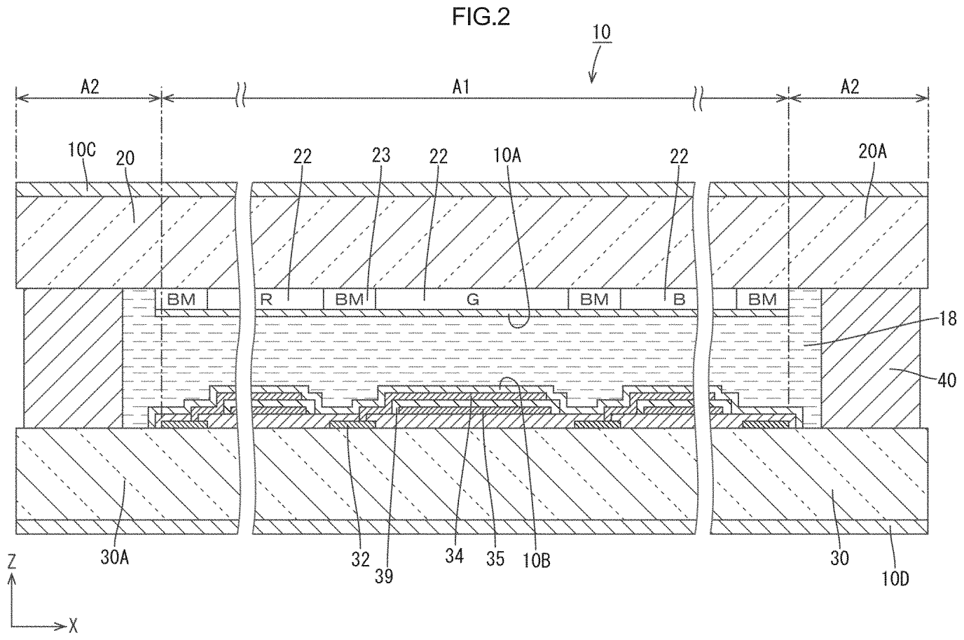

As illustrated in the sectional view of FIG. 2, the liquid crystal panel 10 includes a pair of substrates 20 and 30 and a liquid crystal layer 18 including liquid crystal molecules whose optical characteristics change accompanying the application of an electric field. The two substrates 20 and 30 constituting the liquid crystal panel 10 are bonded to each other with a sealing agent 40 while a cell gap corresponding to the thickness of the liquid crystal layer 18 is maintained between the two substrates 20 and 30. The sealing agent 40 is disposed so as to surround the display area A1. Of the two substrates 20 and 30, the substrate 20 on the obverse side (front surface side) is defined as the CF substrate (counter substrate) 20, and the substrate 30 on the reverse side (back surface side) 30 is defined as the array substrate (active matrix substrate) 30. Aligning films 10A and 10B for aligning liquid crystal molecules contained in the liquid crystal layer 18 are respectively formed on the inner surface sides of the two substrates 20 and 30. Polarizing plates 10C and 10D are respectively bonded to the outer surface sides of glass substrates 20A and 30A constituting the two substrates 20 and 30.

The arrangements of the array substrate 30 and the CF substrate 20 in the display area A1 will be described next. The operation mode of the liquid crystal panel 10 according to the present embodiment is a fringe field switching (FFS) mode (to be described later). As illustrated in FIG. 2, both a pixel electrode 34 and a common electrode are formed on the array substrate 30 side so as to disposed on different layers with an insulating film 39 being sandwiched between the pixel electrode 34 and the common electrode 35. Thin-film transistors (TFTs) 32 as switching elements and the pixel electrodes 34 connected to the TFTs 32 are arranged in a matrix pattern on the array substrate 30. A common electrode line is disposed on the array substrate 30 in the non-display area A2 of the liquid crystal panel 11 and is connected to the common electrode 35.

A reference potential is applied from the common electrode line to the common electrode 35. A predetermined potential difference can be generated between the pixel electrode 34 and the common electrode 35 by controlling a potential applied to the pixel electrode 34 using the TFT 32. A slit-like opening portion is formed in the pixel electrode 34. When a potential difference is generated, the opening portion acts to apply a fringe electric field (oblique electric field) including a component in a direction perpendicular to a plate surface of the array substrate 30 to the liquid crystal layer 18 in addition to a component along the plate surface of the array substrate 30. This makes it possible to properly switch the aligned state of the liquid crystal molecules contained in the liquid crystal layer 18. The liquid crystal panel 10 operating in such FFS mode has advantages of obtaining high viewing angle performance as well as obtaining a sufficient amounted of transmitted light.

As illustrated in FIG. 2, color filters 22 arranged in a matrix pattern are arranged on the inner surface side (liquid crystal layer 18 side) of the glass substrate 20A constituting the CF substrate 20 at positions where the color filters 22 are superimposed on the pixel electrodes 34 on the array substrate 30 when viewed in plan view. The color filters 22 are constituted by, for example, the respective colored portions of red (R), green (G), and blue (B). A first light-shielding portion (black matrix) 23 having an almost lattice-like shape for preventing color mixture is formed between the respective colored portions constituting the color filters 22. The first light-shielding portion 23 is disposed so as to be superimposed on gate lines GLi and source lines SLj provided on the array substrate 30 (to be described later) when viewed in plan view.

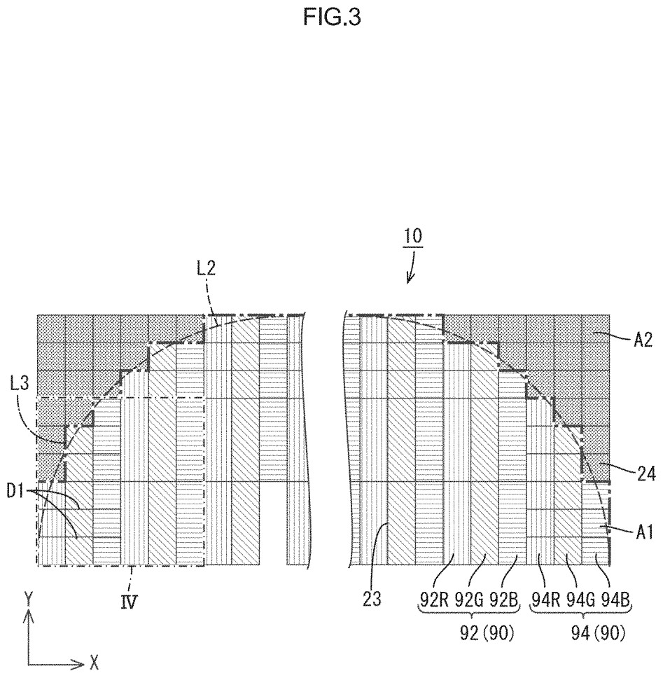

As illustrated in FIG. 2, on the liquid crystal panel 10, one display pixel as a unit of display is constituted by a combination of colored portions of three colors, namely, red (R), green (G), and blue (B), and the three pixel electrodes 34. Each display pixel is constituted by three colored pixels, namely, a red pixel having an R colored portion, a green pixel having a G colored portion, and a blue pixel having a B colored portion. FIG. 3 is a partially enlarged view (an enlarged view of a frame border portion III in FIG. 1) of a plan view of the liquid crystal panel 10. As illustrated in FIG. 3, colored pixels are repeatedly arranged side by side along the row direction (X-axis direction) on a plate surface of the liquid crystal panel 10 to constitute pixel groups. The multiple pixel groups are arranged side by side along the column direction (Y-axis direction).

Of display pixels 90, the display pixel 90 on the central side of the display area A1 will be referred to as a center section display pixel 92, and the display pixel 90 including the curve portion L2 constituting the boundary between the display area A1 and the non-display area A2 will be referred to as a peripheral section display pixel 94. In the respective display pixels, pixels having R, G, and B colored portions will be referred to as a center section red pixel 92R, a center section green pixel 92G, and a center section blue pixel 92B, and pixels having R, G, and B colored portions will be referred to as a peripheral section red pixel 94R, a peripheral section green pixel 94G, and a peripheral section blue pixel 94B.

As illustrated in FIG. 3, the respective colored pixels (center section red pixel 92R, center section green pixel 92G, and center section blue pixel 92B) of the center section display pixel 92 have the same shape (rectangular shape) and size. This makes the aperture ratios of the respective colored pixels uniform and enables display with good color balance. On the other hand, the peripheral section display pixel 94 is formed into small portions as if by equally dividing the center section display pixel 92 into three portions by division lines D1. More specifically, each of the colored pixels (peripheral section red pixel 94R, peripheral section green pixel 94G, and peripheral section blue pixel 94B) constituting the peripheral section display pixel 94 is formed as if by equally dividing a corresponding one of the colored pixels (center section red pixel 92R, center section green pixel 92G, and center section blue pixel 92B) constituting the center section display pixel 92 into three portions by the two division lines D1 along the short side direction of a rectangular shape. Accordingly, the size of the peripheral section display pixel 94 is ⅓ of that of the center section display pixel 92, and the size of each colored pixel of the peripheral section display pixel 94 is ⅓ of that of each colored pixel of the center section display pixel 92. Note that the division lines D1 are formed as linear light-shielding portions that shield light from the lighting device on the CF substrate 20 like the first light-shielding portions 23.

In the present embodiment, of the colored pixels (center section red pixel 92R, center section green pixel 92G, and center section blue pixel 92B) of the peripheral portion display pixel 94, any colored pixel in which the size of the non-display area A2 is larger than that of the display area A1 within the same pixel is configured to make the entire area of the colored pixel become a non-lighted area. More specifically, a second light-shielding portion 24 that shields light from the lighting device is formed in the corresponding colored pixel on the CF substrate 20, thus enabling light-shielding adjustment for each colored pixel. Accordingly, as illustrated in FIG. 3, the boundary between the lighting area and the light-shielding area on the liquid crystal panel 10 becomes that expressed by an approximate line L3 in a stepped shape. When light-shielding adjustment is performed for each colored pixel in this manner, the contour of the display area A1 does not perfectly match the curve portion L2 that is the ideal boundary between the display area A1 and the non-display area A2, and is displayed as the approximate line L3 in a stepped shape along the curve portion L2.

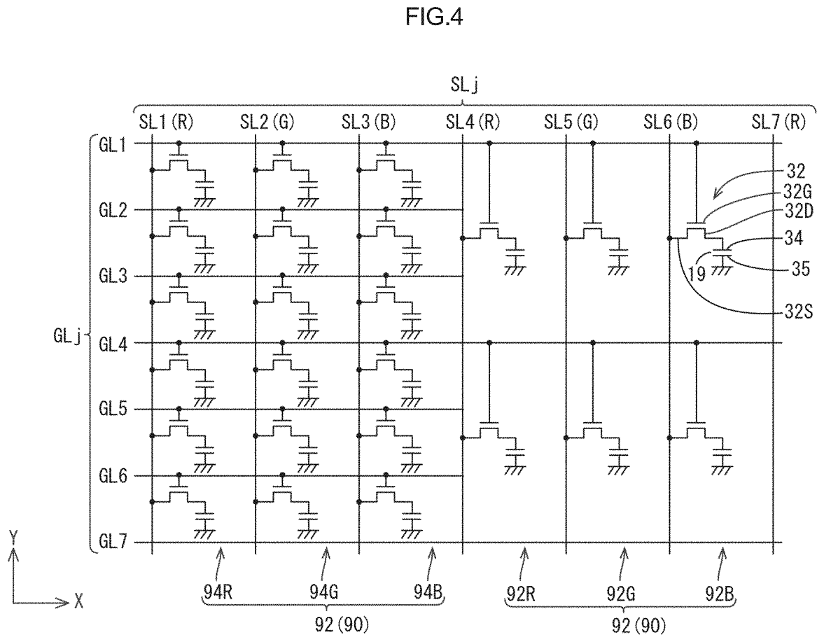

The circuit arrangement of the liquid crystal panel 10 will be described next with reference to the equivalent circuit schematic of FIG. 4. FIG. 4 shows the equivalent circuit of the display pixel 90 surrounded by a frame border portion IV in FIG. 3. The right side portion of FIG. 4 shows the center section display pixel 92 having an array of 2 rows×3 columns (3 colors) of colored pixels, and the left side portion shows the peripheral section display pixel 94 having an array of 6 rows×3 columns (3 colors) of colored pixels. Each colored pixel includes the TFT 32 and the pixel electrode 34. The TFT 32 and the pixel electrode are provided for each colored pixel of the peripheral section display pixel 94. Gate lines (scanning lines) GLi (i=1 . . . 7) and source lines (signal lines or data lines) SLj (j=1 . . . 7) are arranged perpendicular to each other so as to surround the TFT 32 and the pixel electrode 34 in a lattice-like shape. In the peripheral section display pixel 94, gate lines GL2, GL3, GL5, and GL6 are arranged parallel to each other in correspondence with the division lines D1 in FIG. 3. FIG. 4 shows the frame border portion IV in FIG. 3. In view of the overall liquid crystal panel 10, m gate lines GLi, namely, GL1, GL2, . . . extend along the X-axis direction, and n source lines SLj, namely, SL1, SL2, . . . extend along the Y-axis direction.

The TFT 32 is located near the intersection between the gate line GLi and the source line SLj, and a gate electrode 32G, a source electrode 32S, and a drain electrode 32D of the TFT 32 are respectively connected to the gate line GLi, the source line SLj, and the pixel electrode 34. The liquid crystal layer 18 is disposed between the pixel electrode 34 and the common electrode 35 that faces the pixel electrode 34, and hence a liquid crystal capacitor 19 is formed. The gate line GLi is connected to a gate driving circuit formed on the array substrate 20, and the source line SLi is connected to a source driving circuit incorporated in the IC chip 12 described above.

Note that the liquid crystal panel 10 may also have a touch panel function of detecting a position where the user inputs on the basis of a display image. in this case, the array substrate 30 is provided with touch panel electrodes and touch panel lines for implementation of the touch panel function. In addition, there is provided a circuit arrangement in which the common electrode is divided into segments, and the segments are connected to the touch panel lines parallel to the source lines.

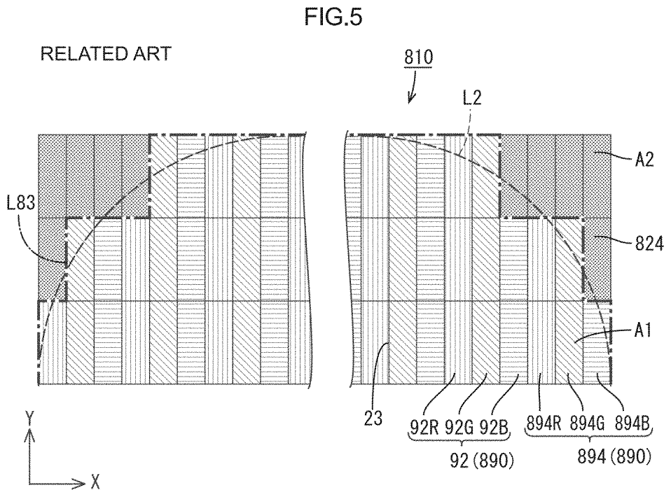

The function effect of the liquid crystal panel 10 according to the present embodiment will be described in comparison with comparative example 1 illustrated in FIG. 5. Unlike in the first embodiment, a liquid crystal panel 810 according to comparative example 1 includes a peripheral section display pixel 894 that is not formed as if by dividing the center section display pixel 92 and has the same shape and size as those of the center section display pixel 92. Accordingly, when light-shielding adjustment is performed for each colored pixel, a second light-shielding portion 824 is formed as illustrated in FIG. 5, and hence the boundary between a lighting area and a light-shielding area becomes an approximate line L83 in the liquid crystal panel 810. A comparison between the approximate line L3 (FIG. 3) according to the present embodiment and the approximate line L83 (FIG. 5) according to comparative example 1 indicates that because the peripheral section display pixel 94 is segmented in the present embodiment, the approximate line L3 is more similar to the curve portion L2 that is an ideal boundary.

As described above, in the liquid crystal panel 10 according to the present embodiment, the peripheral section of the display area A1 is displayed with higher resolution than the center section, and hence the contour of the display area A1 can be displayed more smoothly. In addition, the peripheral section of the display area A1 is subjected to light-shielding adjustment for each colored pixel, and each lighted colored pixel has the same shape and size as those of each adjacent colored pixel, thereby keeping good color balance at the peripheral section.

In the present embodiment, unlike in comparative example 1, the newly provided light-shielding portion includes only the portions corresponding to the division lines D1 that divide the peripheral section display pixels 94. As compared with the center section display pixel 92, the light-shielding portion need not be greatly increased, and hence the peripheral section of the display area A1 does not become too dark. That is, the liquid crystal panel 10 is configured to suppress luminance variations between the center section and the peripheral section of the display area A1.

Each colored pixel of the peripheral section display pixel 94 is provided with the pixel electrode 34 and TFT 32, and the gate lines GLi are arranged parallel. This makes it possible to drive the TFTs 32 provided for the center section display pixels 92 and the peripheral portion display pixels 94 without changing the driving timing chart for the TFTs 32.

### Modification

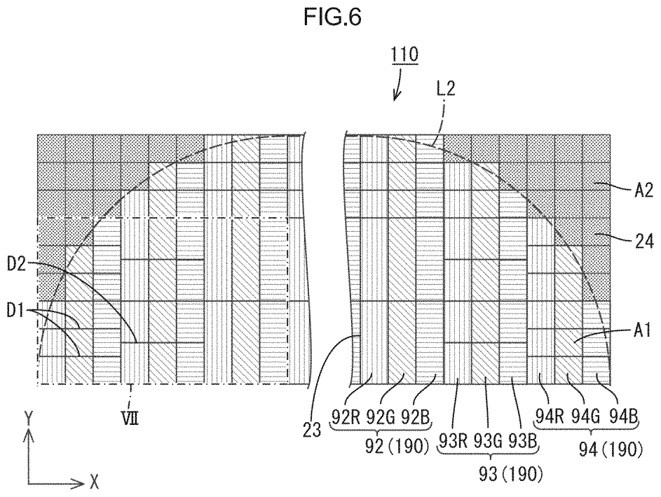

FIG. 6 shows a liquid crystal panel 110 according to a modification. Redundant descriptions of arrangements, functions, and effects similar to those of the first embodiment will be omitted in the modification. The liquid crystal panel 110 includes intermediate section display pixels 93 formed between the center section display pixels 92 and the peripheral section display pixels 94 of display pixels 190 so as to be smaller than the center section display pixels 92 and larger than the peripheral section display pixels 94. The intermediate section display pixels 93 need not be provided between all the center section display pixels 92 and all the peripheral section display pixels 94, and are provided as needed in accordance with the sizes and the like of the curve portion L2 and the liquid crystal panel 110.

As illustrated in FIG. 6, the intermediate section display pixel 93 is formed as if by equally dividing the center section display pixel 92 into two portions. More specifically, each of the colored pixels (intermediate section red pixel 93R, intermediate section green pixel 93G, and intermediate section blue pixel 93B) constituting the intermediate section display pixel 93 is formed as if by equally dividing a corresponding one of the colored pixels (center section red pixel 92R, center section green pixel 92G, and center section blue pixel 92B) constituting the center section display pixel 92 into two portions by one division line D2 along the short side direction of these pixels. Accordingly, the size of the intermediate section display pixel 93 is ½ of that of the center section display pixel 92, and the size of each colored pixel of the intermediate section display pixel 93 is ½ of that of each colored pixel of the center section display pixel 92.

A light-shielding portion corresponding to one division line D2 is newly formed for each colored pixel of the intermediate section display pixel 93, unlike each colored pixel of the center section display pixel 92. In contrast to this, light-shielding portions corresponding to the two division lines D1 are newly formed for each colored pixel of the peripheral section display pixel 94, unlike each colored pixel of the center section display pixel 92. For this reason, when the division lines D1 and D2 have almost the same width, the area of the light-shielding portion of the intermediate section display pixel 93 is between that of the light-shielding portion of the center section display pixel 92 and that of the light-shielding portion of the peripheral section display pixel 94, and the luminance of the intermediate section display pixel 93 is between the luminance of the center section display pixel 92 and the luminance of the peripheral section display pixel 94. Accordingly, in the present modification, the intermediate section display pixels 93 are provided to gradually change the luminance differences between the center section display pixels 92 and the peripheral section display pixels 94, thereby more suppressing luminance variations between the center section and the peripheral section of the display area.

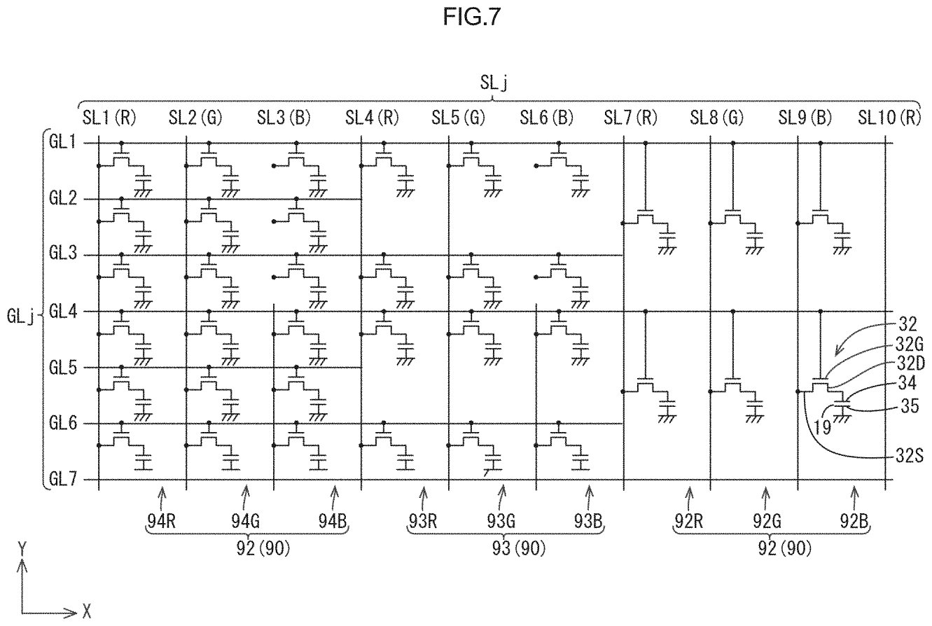

As illustrated in the equivalent circuit of FIG. 7, like each center section display pixel 92 and each peripheral section display pixel 94, each colored pixel of each intermediate section display pixel 93 is provided with the pixel electrode 34 and TFT 32, and the gate lines GLi are arranged parallel. This makes it possible to drive the TFTs 32 provided for the intermediate section display pixels 93 without changing the driving timing chart for the TFTs 32.

### Second Embodiment

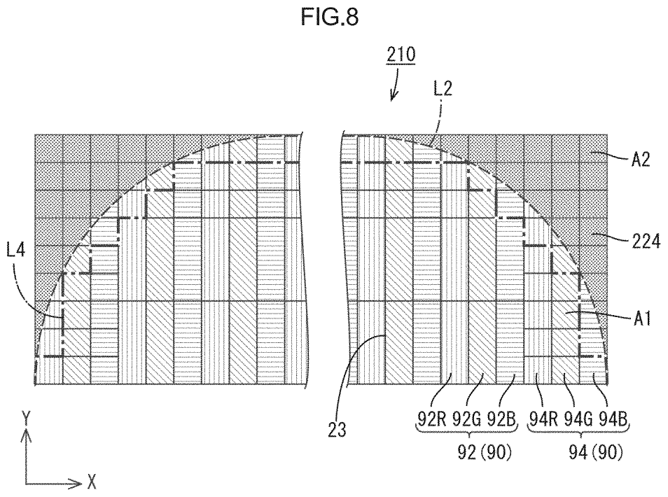

FIG. 8 shows a liquid crystal panel 210 according to the second embodiment. Redundant descriptions of arrangements, functions, and effects similar to those of the first embodiment will be omitted in the second embodiment. The liquid crystal panel 210 is formed such that the boundary between the lighting areas of the display pixels 90 and the light-shielding areas of the display pixels 90 almost matches the ideal curve portion L2. That is, unlike in the first embodiment, light-shielding adjustment is not performed for each colored pixel, and second light-shielding portions 224 are formed along the curve portion L2.

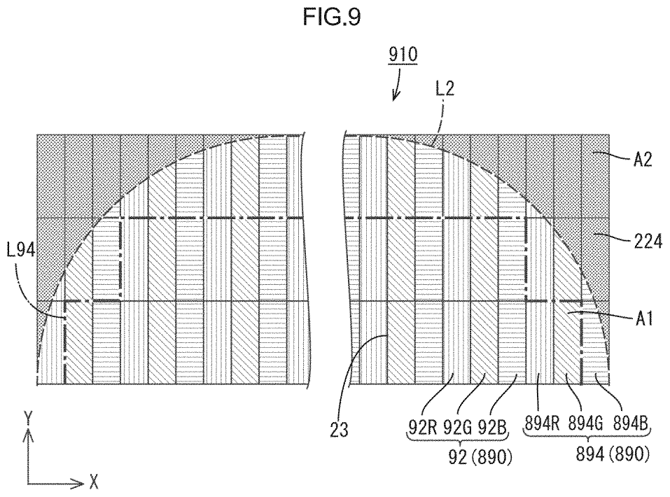

The function effect of the liquid crystal panel 210 will be described in comparison with comparative example 2, illustrated in FIG. 9. In a liquid crystal panel 910 according to comparative example 2, unlike in the second embodiment, a peripheral section display pixel 894 is not formed as if by dividing the center section display pixel 92. The shape and size of the peripheral section display pixel 894 are the same as those of the center section display pixel 92. In both the second embodiment and comparative example 2, in the peripheral section of the display area A1, the boundary between the lighting area and the light-shielding area almost matches the curve portion L2, and hence the contour of the display area A1 is smoothly displayed.

On the other hand, the second embodiment is superior in color balance to comparative example 2. More specifically, a comparison between the ranges of the colored pixels in each of which the entire area in the pixel serves as a lighting area indicates that the range in the second embodiment extends from a color balance holding line L4 illustrated in FIG. 8 to the central side, and the range in comparative example 2 extends from a color balance holding line L94 illustrated in FIG. 9 to the central side. In this area, because the shape and size of each lighted colored pixel are the same as those of each adjacent colored pixel, good color balance is achieved. A comparison between the color balance holding lines L4 and L94 indicates that this area in the second embodiment expands to a range nearer to the curve portion L2. In general, as in the second embodiment and comparative example 2, when light-shielding adjustment is performed along the ideal curve portion L2, each colored pixel including the curve portion L2 has a lighting area as a partial area in the colored pixel. This tends to cause color balance degradation and coloring. In the second embodiment, forming the peripheral section of the display area A1 into a high-resolution portion expands the area in which the color balance of the peripheral section is maintained, thus improving the color balance.

Note that the above modification may be applied to the second embodiment to provide intermediate section display pixels. This makes it possible to further suppress luminance variations between the center section and the peripheral section of the display area.

### Other Embodiments

The technology described herein is not limited to the embodiments described above with reference to the accompanying drawings, and, for example, the following embodiments are included in the technical scope of the technology described herein.

(1) The above embodiments each have exemplified the shape of the display area. However, the shape is not limited to this as long as it includes a curve. In addition, the non-display area is not limited to the outer peripheral section. When, for example, the display area has a doughnut shape, both the inner peripheral section and the outer peripheral section become non-display areas, and both the inner peripheral edge side and the outer peripheral edge side become the boundaries between the display areas and the non-display areas.

(2) The above embodiment has exemplified the case in which each intermediate section display pixel and each peripheral section display pixel are formed as if by equally dividing center section display pixels into two and three portions, respectively. However, each of the pixels may be divided as if by diving a corresponding pixel, and the number of divisions can be set as appropriate.

(3) The above embodiments each have exemplified the case in which each display pixel includes a plurality of colored pixels having R, G, and B colored portions. However, the number and combination of the colors of colored portions can be changed as appropriate. Each display pixel may be constituted by a single colored pixel having a single color.

(4) The above embodiments each have exemplified the TFT as a switching element. However, another type of semiconductor element may be used.

(5) The above embodiments each have exemplified the case in which each pixel circuit is constituted by a pixel electrode and a TFT. However, each pixel circuit may include, for example, an auxiliary capacitor and its accompanying lines.

(6) Each embodiment described above has exemplified the liquid crystal panel whose operation mode is the FFS mode. However, this liquid crystal panel may operate in other operation modes such as an in-plane switching (IPS) mode and a vertical alignment (VA) mode.

(7) Each embodiment described above has exemplified the liquid crystal panel as a display panel. However, the technology described herein can also be applied to other types of display panels (such as organic EL panels, plasma display panels (PDPs), electrophoretic display panel (EPD), and micro-electronic mechanical systems (MEMS) display panel).

1. A display panel comprising:
a plurality of display pixels arranged in a plane of the display panel;
a display area in which an image is displayed; and
a non-display area in which no image is displayed, wherein
a boundary between the display area and the non-display area has a shape including a curve portion,
the display pixels include center section display pixels disposed in a center section of the display area and peripheral section display pixels disposed in sections of the display panel including the boundary between the display area and the non-display area, and
the peripheral section display pixels are formed as if by dividing the center section display pixels.

2. The display panel according to claim 1, wherein the center section display pixels includes intermediate section display pixels in contact with the peripheral section display pixels, the intermediate section display pixels being smaller than the center section display pixels and larger than the peripheral section display pixels.

3. The display panel according to claim 2, wherein
each of the peripheral section display pixels has a shape obtained by equally dividing each of the center section display pixels into three, and
each of the intermediate section display pixels has a shape obtained by equally dividing each of the center section display pixel into two.

4. The display panel according to claim 1, wherein each of the peripheral section display pixels including a portion disposed in the non-display area larger than a portion disposed in the display area includes a light-shielding portion configured to shield light from a light source so that the pixel is not lit.

5. The display panel according to claim 1, wherein each of the display pixels includes a plurality of colored pixels including different colored portions.

6. The display panel according to claim 5, wherein
each of the colored pixels has a rectangular shape, and
each of the colored pixels of each of the peripheral section display pixels is formed as if by equally dividing each of the colored pixels of each of the center section display pixels by division lines along a short edge of the rectangular shape.

7. The display panel according to claim 5, wherein the colored pixels include switching elements, respectively.

8. The display panel according to claim 7, wherein
the switching elements are a thin-film transistors, and
gate lines configured to supply signals to gate electrodes of the thin-film transistors are parallel to each other and provided for the thin-film transistors, respectively.

9. The display panel according to claim 1, wherein the display panel is a liquid crystal panel including a liquid crystal.

10. A display device comprising the display panel according to claim 1.
